(19) United States
(12) Patent Application Publication
(10) Pub. No.: US 2025/0341612 A1
(43) Pub. Date: Nov. 6, 2025

(54) PLATFORM FOR A MOBILE SCANNING ASSEMBLY, AND MOBILE SCANNING ASSEMBLY

(71) Applicant: ZOLLER & FRÖHLICH GMBH, Wangen im Allgäu (DE)

(72) Inventors: Christoph Fröhlich, Wangen (DE); Christoph Held, Lindenberg (DE); Markus Mettenleiter, Isny (DE)

(73) Assignee: ZOLLER & FRÖHLICH GMBH, Wangen im Allgäu (DE)

(21) Appl. No.: 18/268,235

(22) PCT Filed: Dec. 21, 2021
(86) PCT No.: PCT/EP2021/087167

§ 371 Date: Jul. 31, 2024

(30) Foreign Application Priority Data
Dec. 21, 2020 (DE) 102020134414.7
Jun. 11, 2021 (DE) 102021115186.4
Sep. 21, 2021 (DE) 102021124440.4
Oct. 6, 2021 (WO) PCTEP2021077624

(51) Int. Cl. G01S 7/481; G01S 17/42; G01S 17/89

(52) U.S. Cl. CPC G01S 7/4813; G01S 17/42; G01S 17/89

(57) ABSTRACT

Disclosed is a platform for a mobile scanning assembly configured with at least two receptacles for scanning devices.

The invention relates to a platform for a mobile scanning assembly according to the preamble of patent claim 1 and to a scanning assembly configured with such a platform.

Document EP 3 056 923 A1 of the Applicant discloses a scanning assembly with at least one laser scanner that can scan objects located in the field. The scanning assembly is configured with a memory for storing project-related data and an integrated computer and with a navigation unit for detecting a scanner position and/or a relative scanner position to a starting position. Furthermore, the scanning assembly has a satellite computer, for example a tablet, which can perform a registration of the scan in the field in a project-specific coordinate system in parallel with a subsequent scanning process via the laser scanner.

The disadvantage of such a scanning assembly is that it is only mobile to a limited extent. Strictly speaking, the scanning assembly has to be moved from one location to another, wherein the laser scanner is usually mounted on a stand or something similar.

Mobile scanning assemblies with and without SLAM (Simultaneous Localization And Mapping) technology are also known from the prior art. SLAM technology or SLAM mode often has the disadvantage of relatively low pixel density, inhomogeneous coverage of the environment, and comparatively reduced 3D accuracy.

Document EP 3 280 977 B1 shows a mobile scanning assembly that can also be operated according to a SLAM mode, in which a 3D reference map is created in a first step and then, in a subsequent step, based on the 3D reference map, the environment is scanned in a SLAM mode via a 3D scanner and a position determination is performed at the same time, so that the current location of the 3D scanner is known. The current scanner data is then recorded within the existing 3D reference map and can be displayed on a real-time user interface (for example, in a tablet).

According to one configuration example, the 3D laser scanner is positioned on a back frame with shelf, which also carries a CPU for evaluating the data acquired by the scanner and the location data acquired during the SLAM mode. A tablet is also assigned to this scanning assembly, via which information processed by the CPU is displayed.

Furthermore, so-called MMS systems (Mobile Mapping System), which operate in an MMS mode, are known from prior art. The big disadvantage is that no SLAM can be calculated with these data, since the (essentially parallel) profiles do not have sufficient overlap—thus it depends solely on the INS (Inertial Measurement System) accuracy of the MMS system, most times together with a GNSS receiver, which is therefore very high quality and therefore expensive.

Scanning assemblies are also known in which a laser scanner is mounted on a carrier vehicle (SKID, AGVS). This vehicle moves in the environment while the laser scanner takes scans of the environment.

The disadvantage of these known mobile scanning assemblies is that the laser scanner, as one of the main components of the scanning assembly, is only usable for one specific application. A further disadvantage of the existing mobile scanning assemblies is that the respective platforms on which the laser scanners are mounted are only optimized for one application.

In contrast, the object of the invention is to create a platform for a mobile scanning assembly that enables flexible application. The invention is further based on the object of providing a scanning assembly that can be applied this flexibly.

This object is solved with respect to the platform by the features of patent claim 1 and with respect to the mobile scanning assembly by the features of the independent patent claim 12.

Advantageous further developments of the invention are the subject matter of the dependent claims.

The platform according to the invention is configured with at least two receptacles for selective positioning of a scanning device or for positioning of at least two scanning devices, wherein these receptacles are preferably positioned at an angle relative to each other.

Such an arrangement of receptacles makes it possible to position the scanning devices or different scanning devices variably on the platform depending on the respective measurement situation and thus to orient them optimally with respect to the measurement object. Two measurement passes can be performed with a scanning device mounted at different positions. Alternatively, two scanning devices may be mounted at the same time so that two scans can be acquired during one movement of the mobile scanning assembly.

It is particularly preferred if the receptacles for the scanning devices are positioned at a predetermined angle relative to each other, so that optimal orienting is ensured. This also allows undercuts, i.e. areas of a room covered by covers, to be detected.

In a particularly simple configuration example, the platform is configured with two receptacle walls set at an angle relative to each other, on each of which a receptacle is formed. Accordingly, these receptacles are then positioned on compact receptacle walls so that reliable support of the respective scanning device is ensured.

In a particularly compact configuration example, the platform is configured with a bottom which, together with the receptacle walls, side walls and a rear wall, forms a receptacle space for an electronic unit with an onboard PC for controlling the electronic components of a mobile scanning assembly and/or for evaluating measurement signals.

The platform can be adapted particularly well to different conditions if the electronic unit is configured with a DC/DC converter for the accumulators.

In one variant of the invention, retainers for the accumulators are formed on said side walls, into which the accumulators can be inserted without tools and can also be replaced in a correspondingly simple manner. The DC/DC converters can be used to charge the discharged accumulators without removing them. These retainers are preferably formed in such a way that the accumulators are held in a form-fitting and force-fitting manner.

The platform arrangement is particularly compact if two retainers for an accumulator pair are formed on each of the side walls and/or on the rear wall.

In a particularly preferred configuration example of the invention, the receptacles for positioning the scanning devices in the receptacle walls are configured essentially identically.

It is particularly preferred if the receptacles are formed by pocket-shaped recesses, into each of which a retainer for a scanning device can be inserted.

Such a retainer is preferably configured with a flange plate that is precisely inserted into the recesses and carries a holding flange for the respective scanning device. This holding flange is standardized so that different scanning devices, for example a 3D scanner, a 2D scanner, a camera module or other extensions, are attachable.

The mobile scanning assembly according to the invention is configured with such a platform, wherein at least one scanning device, in particular a laser scanner, is attached to a receptacle and is in power and signal connection with the electronic unit.

The platform may be mounted on a mobile carrier unit, such as a cargo backpack, a SKID, an AGVS, a pushcart, a car, a quad or a boat. Of course, the platform may also be mounted in a conventional manner on a stand or the like for taking a static scan.

In a preferred configuration example, a 3D laser scanner and/or a 2D laser scanner, a device for location detection and optionally at least one color camera are arranged on the mobile carrier unit, wherein these are each in power and data connection with the accumulators or the electronic unit, respectively.

The mobile scanning assembly according to the invention correspondingly has a mobile platform on which at least one scanning device for 2D or 3D measurement of objects/regions is arranged. The platform is held in such a way that it can be moved along a predetermined path of movement along the region to be measured and has an electronic unit (computing unit (CPU)) that is in data connection with the scanning device. The mobile scanning assembly furthermore has a device for location detection. The computing unit makes it possible to evaluate the data determined via the scanning device, which is preferably operated in an MMS rotation mode, in particular an MMS SLAM rotation mode, and the device for location detection, and to determine a trajectory (movement path) of the scanning device, wherein the computing unit is adapted, in the event of insufficient data quality of the trajectory or of the resulting scan, to determine at least one position for additionally performing a static scan and/or to output a corresponding information and/or a signal for performing a further mobile scan, preferably in a profile mode.

Such a mobile scanning assembly can be used very flexibly, wherein it is ensured that due to the different measuring principles (static mode and MMS mode) a highly precise detection of the object or the region to be measured, for example a production hall, is possible.

In a preferred configuration example, the computing unit integrated in the platform is synchronized with at least one of the scanning devices so that the scans and location data acquired in mobile and/or static mode can be synchronized with the scan data stored in the scanning device. In this context, it is particularly preferred if the computing unit is configured in such a way that it can process the scans and location data acquired in mobile and/or static mode with the aim of registration in the field (on site). This registration can then be carried out via the computing unit or via an external computer assigned to the scanning device.

It is particularly preferred if the computing unit is adapted in such a way that the processed data sets/scan data can be transmitted back to the evaluation unit of the scanning device—in other words, the synchronization of the data sets takes place between the platform-side computing unit and the at least one scanning device in both directions.

In one variant of the invention, the aforementioned pre-registration in the field takes place via an external computer, for example a tablet (handheld device) or via the computing unit, which is in data connection with the scanning device.

Further processing in a central processor or the like is facilitated if the computing unit has an interface for an external memory, for example an SSD or a USB stick, on which the project data, i.e. the data resulting from the synchronization of the computing unit and the internal computer of the scanning device, can be stored. The project data can also be stored centrally on an external computer via an interface.

The location detection device may be an IMU/INS-based and/or GNSS-based system or a system that uses localization techniques such as radar, Bluetooth, ultrasound, or RFID, etc.

A method for driving a mobile scanning assembly, in particular a mobile scanning assembly with the preceding features, accordingly assumes a scanning device that is positioned on a mobile platform and that is configured with a computing unit that is synchronized with the scanning device. Preferably, driving of such a mobile scanning assembly is performed in such a way that, in a first step, a mobile data set is generated via the scanning device, which is preferably operated in an MMS rotation mode, in particular an MMS SLAM rotation mode, and is assigned to the object/region to be measured. This mobile data set acquired via the scanning device is then evaluated via the computing unit and a trajectory is calculated. This is the basis of the evaluation, since it is the only way to locate the profiles in 3D.

In a further step, the trajectory or mobile data set (scans) is analyzed and, if applicable, a signal is output for performing a static scan from a location determined by the computing unit or another mobile scan, preferably in a profile mode of the scanning device.

The static scan or the further mobile scan and the mobile data set from the first measurement are then evaluated to determine a corrected mobile data set and a corrected trajectory, which are synchronized with the scanning device if applicable.

Such a method enables high-precision detection of an object/region to be measured with a minimum of device-related and process engineering effort.

The method according to the invention is particularly effective if, on the basis of the corrected data set in the field, a pre-registration or a correction of a registration is carried out via the computing unit or via an external computer in data connection with the scanning device. This external computer may, as mentioned above, for example be a tablet associated with the scanning device.

Further processing of the trajectory and data sets is particularly easy if these data are stored on an external memory, which then serves as a backup to the internal memory.

The method described above can be used particularly effectively in a scanning assembly with a 3D laser scanner, via which a first mobile data set is generated in an MMS rotation mode, preferably a SLAM rotation mode, and, if applicable, the static scan. It is preferred if at least a second mobile data set is generated via the 3D laser scanner operated in a profile mode along the same path of movement (if applicable in the opposite direction) or via a further 2D laser scanner held on the platform. This double detection of mobile data sets results in an optimization of the trajectory and the resulting 3D cloud of points, wherein all available data and loop closures from other passes, control points and also the aforementioned static scans can be taken into account via the CPU.

The acquisition of the static scan is particularly accurate if the scanning device is removed from the platform and moved to an optimal measuring position. The 3D laser scanner or scanning device can then be mounted on a stand or the like.

Further innovative aspects of the invention are addressed below.

The platform, on which all components can be precisely mounted, can be configured differently depending on the application. The platform may contain several, preferably adjustable, devices to hold one or more scanners at different angles.

The laser scanner, which can be detachably attached to the platform in a defined orientation (preferably vertically or tilted backwards) so that it can be removed at any time and can be set up on a stand in the traditional manner, is also adapted to take static scans. A particular advantage of this configuration of a scanning assembly is its mobile and flexible applicability. The scanner can be operated both on the platform and independently as a stand-alone device at fixed viewpoints. The platform is also adapted in such a way that it can be mounted on a SKID/push cart or a carrying frame or any other mobile carrier device.

Preferably, the scanning assembly has an integrated or separate camera unit consisting of several cameras that record images in the visible and/or infrared and/or multispectral range. This camera unit is preferably configured as a 360° panoramic camera system, whereby the entire environment can advantageously be captured in a data set also referred to as a panorama. In principle, it is also possible to use a camera or camera assembly that captures color images in parallel to the scan profiles, wherein the scanner and the camera assembly are then operated in a profile mode, so to speak. Such a concept is used, for example, in the ‘Z+F MapCam®’ camera system.

In a particularly preferred configuration example, the platform of the scanning assembly has an electronic unit that contains essential electronic components required for generating supply and control signals as well as the computing unit and a navigation system (INS (Inertial Navigation System) & optionally GNSS (Global Navigation Satellite System)). The electronic unit can also be used to establish a preferably wireless connection from the computer to a handheld device, e.g. smartphone, tablet or the like, via which the operator can control and/or monitor the overall system.

The transformations relative to the INS (Lever Arms) of the scanner and camera are preferably determined by calibration, so that the data of all components, synchronized via a common ‘PPS’ pulse, can be transformed into a uniform coordinate system.

Preferably, the platform and/or the electronic unit is adapted to hold a base board. This base board is used, among other things, for coupling and connecting different components of the scanning assembly.

As explained, a computing unit is mounted on or in the platform and/or is part of the electronic unit. Since this is directly or indirectly connected to the platform, it is also referred to as an onboard PC and can be used directly in the field. It can control the individual components and/or generate a live preview that is displayed to a user on a satellite computer, such as a handheld device, tablet, or the like. The computing unit may also be part of a separate camera unit.

Depending on the configuration, it may be advantageous to provide accumulators for supplying power to the electrical components. Particularly preferably, the accumulators are attached to or in the platform in such a way that they are easily accessible and can thus be replaced in a short time. This exchange can take place during a scanning process so that it does not have to be interrupted. Thus, during a measurement in the field, the running time of the scanning assembly can be significantly extended by replacing the accumulators. Furthermore, the accumulators may be integrated in or on the platform in such a way that they also supply the laser scanner with power, so that the accumulators of the laser scanner are not necessarily held on the laser scanner itself. This reduces the weight of the laser scanner and the rotating mass, which is beneficial for the quality of the images.

In an advantageous embodiment, a DC-to-DC converter is provided for the scanning assembly, which is also held on or in the platform, in particular as part of the electronic unit. Advantageously, different accumulator types can be used. The voltages may be between 6V and 48V and the DC-to-DC converter adapts these to the operating voltage of the scanning assembly or the individual components.

In a preferred further development, the laser scanner is connected to the platform via an adapter with a receptacle device attached to the platform. Advantageously, exact orienting is thus ensured in a simple manner which is also sufficiently reproducible.

In a particularly preferred configuration example of the mobile scanning assembly according to the invention, an inertial sensor is provided on the platform that is oriented such that its orientation to the laser scanner is fixed and known.

In an alternative configuration example, the onboard PC and most of the other components of the electronic unit are integrated inside the platform so that external data carriers are connectable via interfaces. Advantageously, the entire platform can be converted from one portable device to another without having to dismantle and reassemble individual parts of the electronic unit.

For example, a cargo backpack, such as a so-called Kraxe, i.e. a back frame with shelf, is used as the portable carrier device. The platform can be mounted on the carrier device, for example the Kraxe, in just a few steps. Advantageously, such Kraxen are ergonomically optimized, so that a user can bear the load of the scanning assembly even over a longer period of time without problems.

In a further preferred configuration example, the carrier device is a production platform. In particular, it may be a so-called SKID or an AGVS (automated guided vehicle system), which are used, for example, in larger production lines, for example in the automotive industry. The platform can be quickly mounted on a SKID conveyor or the AGVS without intervening in the production process and can scan and detect the entire production hall in one pass. A SKID is preferably used to scan the interior space of the production hall, while walking/travel paths and outdoor facilities are preferably scanned via an AGVS.

In an alternative preferred configuration example, the carrier device is an item that can move in a variety of ways. For example, it may drive, fly (drone), or swim.

A configuration example of the method has the following steps:

In a first step, the target object is acquired in one pass in a SLAM rotation mode. This is a typical operating mode of SLAM systems already available on the market. Advantageously, large regions can be captured very quickly from a continuous motion.

In a second optional step, the scene is captured in an MMS profile mode. This mode is primarily used in classic, mostly vehicle-based, MMS systems. The advantage is being able to scan large regions quickly, wherein the accuracy and data density is much higher and also more homogeneous than when using a SLAM-rotation mode.

In a third, optional step, single scans are taken at stationary points where a very high resolution is required. These single scans are performed in a classical laser scanner mode, where many single points are acquired. Advantageously, the resolution and the 3D accuracy are very good in this mode.

The individual steps are shown in more detail below.

According to the first step, a very accurate SLAM-based trajectory of the scan's motion is generated after the measuring is completed, wherein already a favorable INS can be sufficient to estimate the position. If possible, at least one loop closure (return to the starting point or to individual objects during the detection) is acquired to compensate for slow drifts of the trajectory.

In the second step, for example, the same route from the first step is run or traversed again, wherein, however, scanning is performed in profile mode. The (approximately parallel) profiles are oriented using the SLAM algorithm based on the data already generated from the first pass, greatly increasing the data density and homogeneity of the 3D data while maintaining approximately the same accuracy. As a support for trajectory determination, other sensors can be used, such as cameras/GPS etc.

In an optional third step, individual scans in the classic laser scanner mode, i.e. a spherical 3D scan at a fixed viewpoint, can be acquired at a few, particularly critical, points, either in order to determine certain reference objects with high precision, or to measure certain objects with particularly high resolution, or to support the trajectory at difficult points of the SLAM passage. The individual viewpoints are at least approximately known to the system, either via the SLAM algorithm or via the internal sensors of the scanning assembly or of the laser scanner, so that these scans can advantageously be registered seamlessly with the existing data set.

Advantageously, by using the method according to the invention, a high-resolution, high-precision 3D cloud of points of a large region is obtained in a short time, wherein accuracy and resolution approximately correspond to that of the classical laser scanner mode—and this without the use of expensive INS systems. Likewise, the use of additional laser scanners can be dispensed with in an advantageous manner.

In a preferred configuration example, the individual images, also called 3D scans, are registered in the field. Once the scans from the laser scanner mode have been registered to the data set acquired in SLAM mode, they can, due to their high accuracy, serve as a reference in order to orient the profiles of the SLAM data set even more precisely, which is preferably done automatically. Also, several independent but overlapping SLAM data sets could serve each other as reference. In the case of captured reference objects, the trajectory computed in SLAM can be drawn to so-called ‘tie-points’ and can thus be improved with high precision. Of course, tie points may also be generated in other ways, for example by the camera system or with the help of target marks captured by the laser scanner in static use. These may also be simple geometries such as planes, lines, spheres, cylinders or something similar.

Similarly, the trajectory estimation for the SLAM data set can be improved by including, for example, differential GNSS data.

In a preferred configuration example of the method according to the invention, the camera unit can advantageously be used to further improve the trajectory via appropriate video geometry evaluation, for example estimation of the motion by tracking features in successive images, or video SLAM.

The second step can be saved if the scanning assembly used is equipped with an additional profile scanner that acquires additional approximately parallel profiles already during the first pass and whose data is oriented to the data of the first scanner using the SLAM process.

Configuration examples of the invention are explained with reference to drawings.

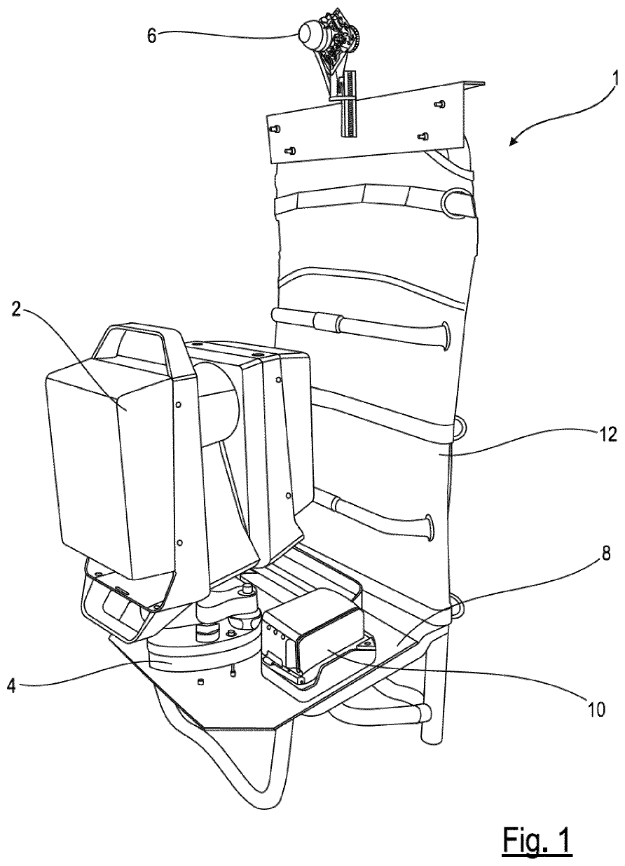

FIG. 1 shows a configuration example of a mobile scanning assembly according to the invention in a perspective illustration,

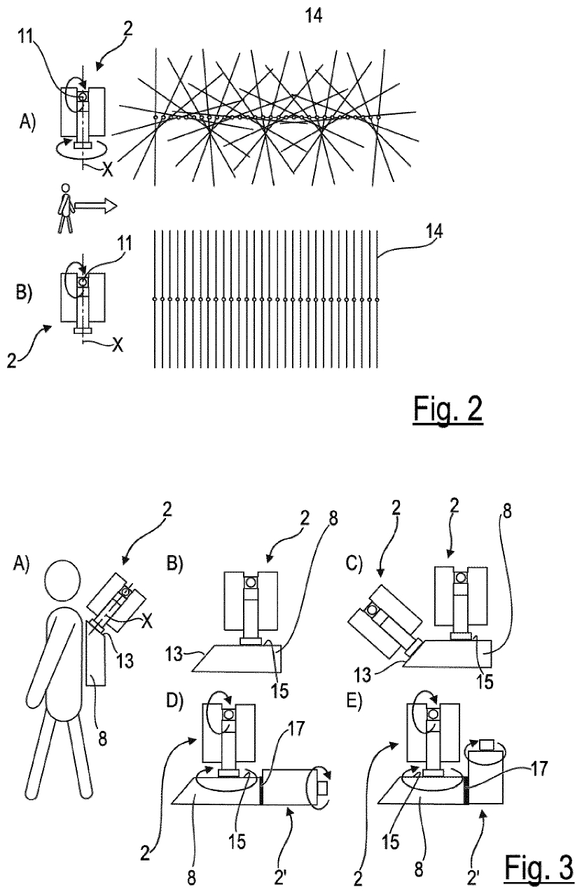

FIGS. 2a and b show a laser scanner in two different operating modes,

FIGS. 3a to 3e show different arrangements of a mobile scanning assembly with regard to the positioning of the components on a platform;

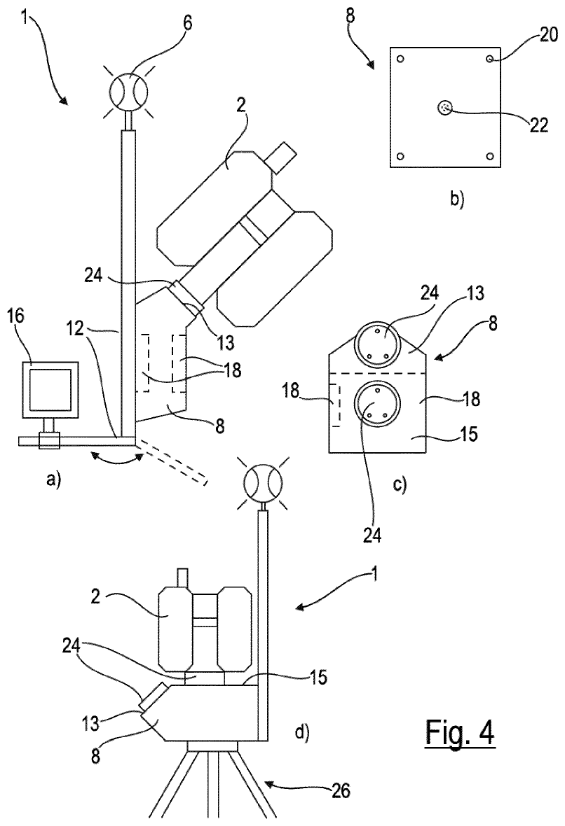

FIGS. 4a to d show examples of use of a mobile scanning assembly according to the invention;

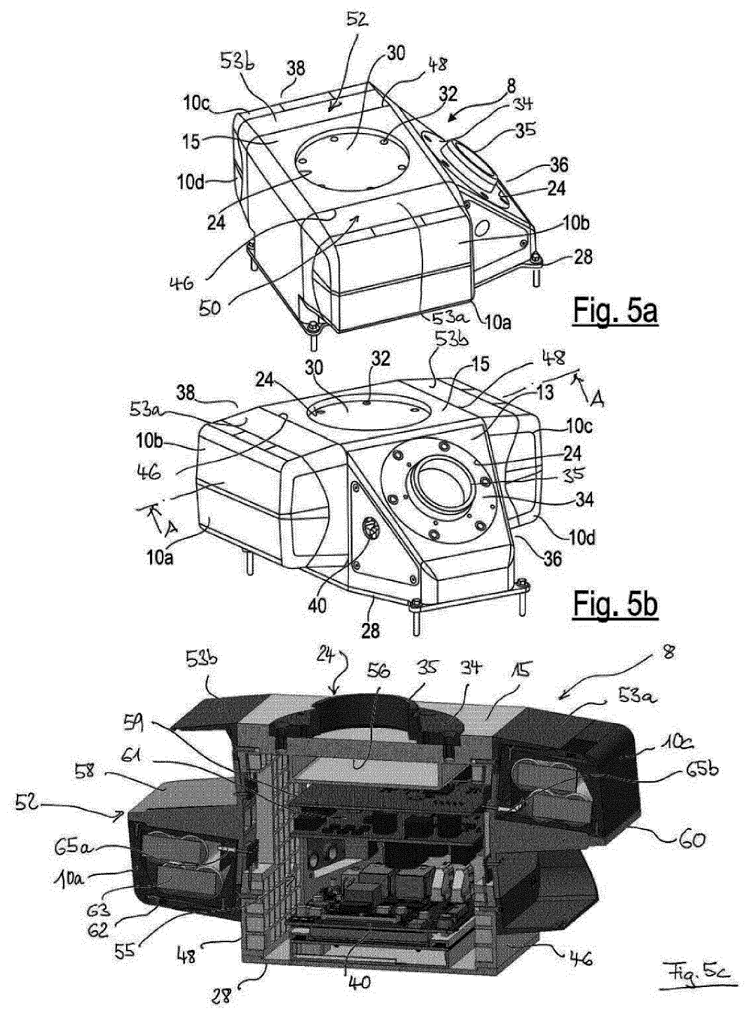

FIGS. 5a, 5b show three-dimensional views of a platform of the scanning assembly according to the invention;

FIG. 5c shows a sectional view of the platform according to FIGS. 5a and 5b;

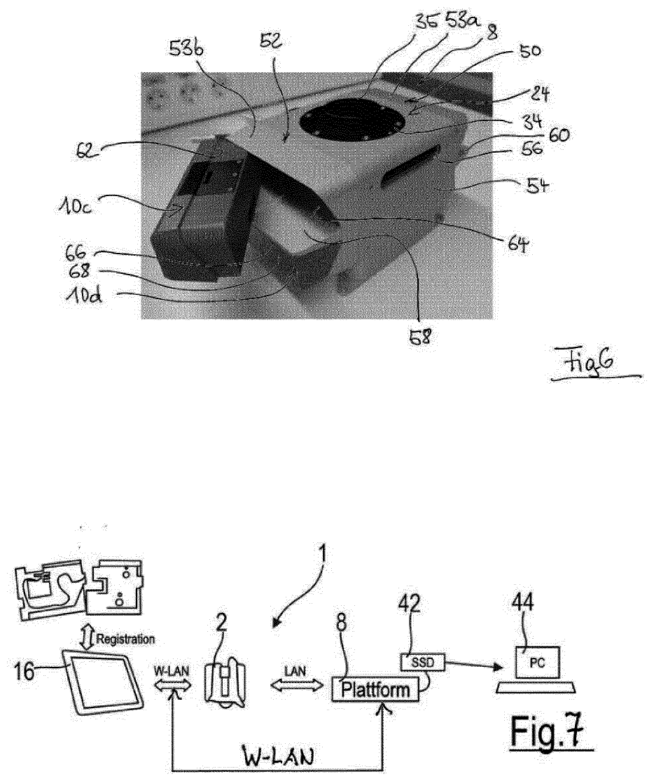

FIG. 6 shows a variant of a platform according to FIGS. 5a, 5b;

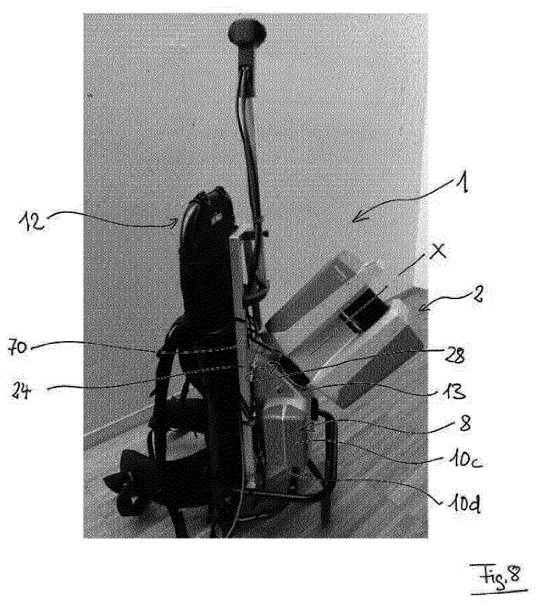

FIG. 7 shows a basic illustration of essential components of a scanning assembly according to the invention;

FIG. 8 shows a configuration example of a mobile scanning assembly with a cargo backpack;

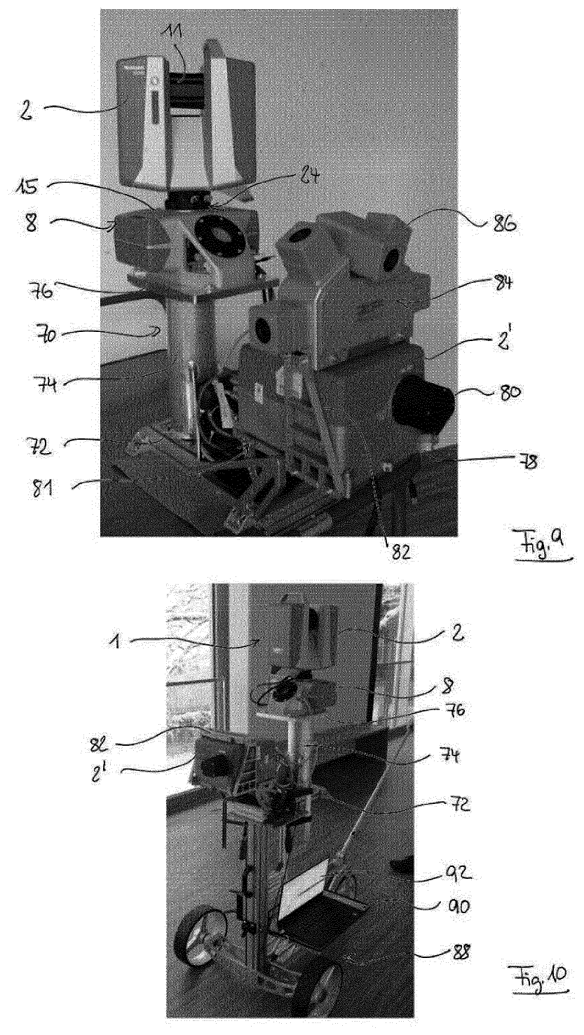

FIG. 9 shows a configuration example of a mobile scanning assembly with two scanners and a camera system;

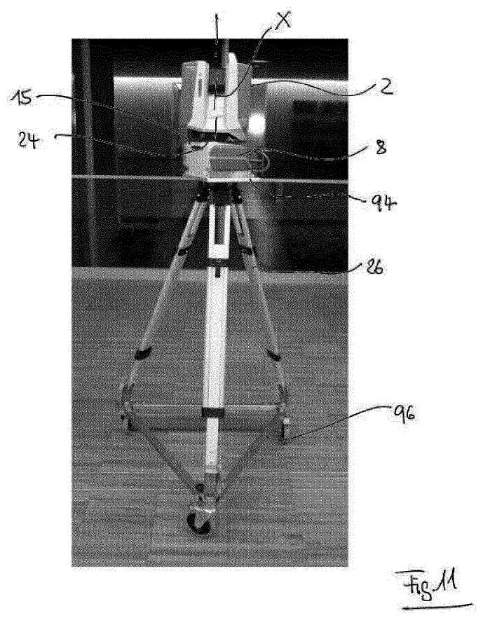

FIG. 10 shows a variant of the configuration example according to FIG. 9; wherein the mobile scanning assembly is mounted on a pushcart and

FIG. 11 shows a scanning assembly with a stand on an optional wheeled frame.

FIG. 1 shows a configuration example of a mobile scanning assembly 1 not according to the invention. It has a 3D laser scanner 2, which in this configuration example is mounted on a tripod 4 or another support bracket. Furthermore, the scanning assembly 1 has a camera unit 6 that is spaced apart from the laser scanner 2. The camera unit 6 is arranged in such a way that it has a largely unobstructed view of the scene. The camera unit 6 is also spaced from a platform 8 supporting the laser scanner 2—it is also conceivable that the camera is integrated in the platform or in the scanner in order to record images in profile mode with a view as parallax-free as possible. The laser scanner 2 is connected to the platform 8 via the tripod 4 or another suitable device and a receptacle described in more detail below, wherein an inclined (approx. 45° inclination) or vertical position is preferred. If the orientation of the laser scanner 2 on the platform 8 is not exact, this can be compensated for by an electronic compensator of the laser scanner 2.

An inertial sensor not shown in the Figure should be positioned in a predetermined relative position, preferably, approximately centered below the laser scanner 2.

The platform 8 is configured with an electronic unit, which is configured with an onboard PC and a DC-to-DC converter. The onboard PC has for example threads on its rear side, which are for example formed in the manner of a VESA receptacle. Thus, the onboard PC, which is configured with rubber feet, if applicable, can be screwed to the platform or can be secured against slipping and vibrations with another type of mount within the technology unit.

At least one accumulator 10 is mounted on an upper side of the platform 8. Preferably, several accumulators 10 are held on the platform 8 in such a way that they are easily replaceable in order to enable a longer scan time in the field. The accumulators are preferably interconnected in such a way that at least one accumulator can be replaced without interrupting the scan.

In this configuration example, the camera unit 6 is attached to a cargo backpack 12 via an angled bracket. A profile is attached approximately in the middle of the angled bracket, to which the camera unit 6 is mounted. The angled bracket is, for example, screwed to a frame of the cargo backpack 12 on both sides, or is detachably attached in another way. In particular, it is advantageous if the mounting of the camera unit 6 is configured in such a way that it is rigidly configured relative to the frame of the cargo backpack 12. This makes calibration of the scanning assembly 1 much easier. Cables of the camera unit 6 are routed along a side of the cargo backpack 12 facing away from a user to the onboard PC.

The mobile scanning assembly 1 has a total of three operating modes, wherein the third operating mode is explained in more detail in a later figure.

FIG. 2 schematically shows two operating modes (MMS rotation mode, profile mode) of the laser scanner of the mobile scanning assembly 1 according to the invention.

In MMS or SLAM rotation mode, the laser scanner 2 is located on the moving platform 8 according to the invention and rotates (a few times per second) around its vertical axis X, while a rotor 11 ensures a rapid vertical deflection of the scanning laser beam 14. According to the illustration in FIG. 2a, a helix of vertical profiles twisted around the vertical axis is created (by the horizontal movement of the platform), which thus have a large overlapping area. This overlap is essential for the SLAM algorithm, which can calculate the exact trajectory and thus the transformation of all recorded data only from this (and the motion estimation of the INS).

FIG. 2b shows the second operating mode (profile mode). Accordingly, only the rotor 11 rotates for vertical beam deflection. The laser scanner 2 does not rotate around its vertical axis X, but keeps it at a defined angle, preferably approximately perpendicular to the direction of movement of the platform. The profiles of the laser beams 14 captured in this way are therefore approximately parallel to each other. Due to the parallel arrangement of the captured profiles, such a measurement alone cannot be used for evaluation via a SLAM algorithm, since this requires overlapping profiles. This only applies to the detection of profiles via laser scanners—if cameras are used, SLAM is also feasible in principle. However, such concepts have only a relatively low measurement accuracy.

The illustrations in FIG. 3 show different ways of positioning the scanning assembly according to the invention.

According to FIG. 3A, the mobile scanning assembly is mounted, for example, on a cargo backpack or a back frame with shelf, wherein the platform 8, as explained in more detail below, is configured as a housing on which the respective laser scanner 2 is mountable in a variable position. In the configuration example shown, the platform 8 has a slanted surface 13, which in the configuration example shown is set at an angle of about 45° to the vertical (of course, other angles are also possible). The laser scanner 2 is then mounted on this slanted surface 13 via a suitable adapter so that it is rotatable about its vertical axis X, for example in an operating mode as shown in FIG. 2A. The inclined position ensures that a collision between the person carrying the scanning assembly and the laser scanner 2 is not to be expected while walking through the region to be measured. Such an arrangement can also be used, for example, when mounting the scanning assembly on a sliding carriage, wherein the platform 8 is then arranged in the horizontal direction so that the vertical axis X of the laser scanner 2 is oriented upward in the sliding direction. When using a sliding carriage, however, it could also be advantageous if the vertical axis X of the laser scanner is set at an angle, preferably 45°, in the direction of travel.

However, as indicated in FIG. 3B, the laser scanner 2 may also be mounted on one of the large surfaces 15 adjacent to the aforementioned slanted surface 13. In such a concept, the platform 8 is accordingly preferably arranged in a lying manner. Such a platform arrangement is advantageous, for example, when mounting the scanning assembly on a sliding carriage, a SKID, an AGVS or the like.

The measuring speed and the flexibility of the arrangement can be improved by occupying both the large surface 15 and the slanted surface 13 with a laser scanner 2, according to FIG. 3E. Accordingly, the platform 8 is then configured with receptacles for the laser scanners 2 at the large surface 15 and the slanted surface 13 formed as a respective receptacle wall. For example, one of the laser scanners 2 can be operated in the SLAM rotation mode, while the other laser scanner 2 operates in the profile mode described above. The evaluation of both scans to determine the mobile data set and the trajectory is then performed by the onboard PC described in more detail below.

In this configuration example, the platform 8 is also arranged in the horizontal direction.

In the configuration example according to FIG. 3D, a 3D laser scanner, for example the Z+F IMAGER® of the Applicant, is mounted on the large surface 15, while a 2D laser scanner, for example the Z+F Profiler® 2′ of the Applicant, is mounted on a narrow side 17 of the platform 8 running in the vertical direction. Accordingly, the Z+F IMAGER® is used for the rotation mode and the Z+F Profiler® 2′ for the profile mode. Both measurements can be performed simultaneously.

In principle, it is also possible to fill both positions with a Z+F IMAGER® 2 or a Z+F Profiler® 2′. When using two scanners, the SLAM algorithm can be used, since the profiles overlap due to the oblique position.

Finally, FIG. 3E shows a relative positioning in which the Z+F Profiler® 2′ is arranged on the narrow side 17 in the vertical direction so that the profile is correspondingly detected in the horizontal direction. Naturally, other arrangements are also possible.

FIG. 4a shows a mobile scanning assembly 1 with a laser scanner 2 that is held at an angle of approximately 45° on the slanted surface 13 of the platform 8. This is held on the frame of a cargo backpack 12. This frame has, inter alia, a detachable handheld device 16 (tablet) in a lower, angled region. Furthermore, the detachable camera unit 6 is shown, which is provided at an upper end of the cargo backpack 12. The platform 8 has lateral battery compartments 18 indicated with dashed lines, into which accumulators can be inserted to power the mobile scanning assembly 1. This will be explained in more detail below.

FIG. 4b shows an underside of the platform 8 with which it can be mounted on a transport device. For this purpose, thread holes 20 are provided in corner areas of the platform, via which relatively small screws can hold the platform on the intended transport device. A somewhat larger thread hole 22 is provided centrally or at the center of gravity on the underside of the platform 8, via which a central screw connection to the transport device can be achieved.

FIG. 4c shows an upper side of the platform 8, wherein the slanted surface 13 is indicated in a region shown here above and indicated by a dashed line, which is positioned, for example, at an angle of approximately 45° to the large surface 15 of the platform 8. Receptacles 24 are provided both in the slanted surface 13 and on the large surface 15 of the platform 8, which are used for receiving laser scanners 2. The receptacles 24 may be configured, for example, as a bayonet lock or may have an external thread, or may have receptacle bores and/or may also have threaded bolts, press pins that are used for fixed positioning of the laser scanner(s) 2, 2′.

FIG. 4d shows a mobile scanning assembly 1 with the laser scanner 2, the camera unit 6 and the platform 8, which has two receptacles 24, on a stand 26. This arrangement is used, for example, to apply the third operating mode described below.

In the third operating mode, the laser scanner 2 is preferably dismounted and takes a conventional panoramic scan from a fixed viewpoint, typically a stand 26. If the platform 8 is standing still, the scanner can also remain mounted on the platform 8 to take a conventional 360° scan.

In the configuration example shown in FIG. 4d, the scanner 2 is mounted with the platform 8 on the stand 26. In principle, the scanner 2 can also be detached from the platform 8 and can then be positioned on a stand 26 or something similar. In this case, however, it has to be ensured that the static scans are synchronized with the onboard PC of platform 8. In the concept according to the invention, this is performed automatically by the platform 8 when the scanner 2 is connected to the platform 8.

FIGS. 5a, 5b show specific embodiments of the platform 8. As already explained above, this is mounted with a bottom wall 28, which in turn is mounted via screws or the like on the respective mobile support structure, for example the cargo backpack 12, the SKID, an AGVS or a pushcart.

As explained, the platform 8 has a housing with a receptacle wall forming the large surface 15, which runs parallel to the bottom wall 28. A receptacle 24 for a support bracket of a laser scanner 2 (Z+F IMAGER®, Z+F Profiler®) is arranged in this receptacle wall. In the configuration example shown, the receptacle 24 is pocket-shaped, wherein fastening threads 32 for a flange plate 34 are provided at a bottom 30. This carries a holding flange 35, which is configured in accordance with the mechanical interface of the laser scanner 2. This holding flange 35 may be configured with dowel pins or the like, so that precise, rotation-proof mounting of the laser scanner 2 is ensured.

In the illustration according to FIG. 5a, the large surface 15 is followed to the right by the slanted surface 13, on which a receptacle 24 is also formed, into which a flange plate 34 with a holding flange 35 for the laser scanner 2 is inserted according to the illustration in FIGS. 5a and 5b.

Up to four accumulators 10a, 10b, 10c, 10d are positioned on side walls of the platform housing, wherein each of these accumulators is individually replaceable and interconnected to provide power during operation of the laser scanner(s) 2 and the platform components. In the configuration example shown, the four accumulators 10a, 10b, 10c, 10d are positioned in the region of the side walls 46, 48 of the housing adjacent to the large surface 15.

In the configuration example shown, retainers 50, 52 are formed on the two side walls 46, 48 of the platform 8, which surround the accumulators 10a, 10b or 10c, 10d and into which the respective accumulator pair (10b, 10a; 10d, 10c) can be inserted with a precise fit, wherein contacting then takes place via corresponding contacts in the region of the side walls 46, 48, which additionally contribute to fixing the position of the accumulators 10a, 10b, 10c, 10d in the retainers 50, 52. The geometry of the retainers 50, 52 is configured to match the outer contour of the accumulator pairs 10a, 10b; 10c, 10d and is formed in such a way as to ensure a continuous transition between the actual housing region and the accumulator holder.

A housing region 36 forming the slanted surface 13 is also laterally slanted compared to a housing region 38 forming the large surface 15, so that, toward the viewer, the slanted surface 13 runs correspondingly narrower than the large surface 15. Accordingly, the housing region 36 tapers toward the viewer in both the vertical direction and in the horizontal direction (view according to FIG. 5b). The housing regions 36, 38 house the onboard PC described above, which is configured to be very powerful so that it can perform the data processing described above directly at high speed. The housing furthermore includes the communication interface which performs synchronizing the data processed by the onboard PC with the data sets stored in the laser scanner(s) 2. Furthermore, there may be an additional communication interface in the housing for a data connection with an external computer (tablet, handheld device) 16. In principle, however, it may also be sufficient if this communication takes place via the respective scanning device (for example, the laser scanner 2). Parts of the onboard PC and of the communication modules are marked with the reference sign 40 in FIG. 5b.

FIG. 5c shows a section along line A-A in FIG. 5b, wherein the two accumulators 10b, 10c are removed from the retainers 50, 52. These are configured with retainer walls 53a, 53b respectively surrounding the pair of accumulators, between each of which a separation wall 58, 60 extends, which is arranged between the two adjacent accumulators 10a, 10b; 10c, 10d and thus keeps them at a distance from each other. Reference will be made to this later in connection with FIG. 6.

As explained, the bottom wall 28, the receptacle wall configured with the large surface 15, the receptacle wall formed with the slanted surface 13 and the side walls 46, 48 form a receptacle space 55 for the onboard pc 40 visible in section. A microcontroller board and the INS system 59 and a circuit board for the power supply 61 are also arranged in this receptacle space 55. These are fixed in position in corresponding retainers of the receptacle space 55. In the illustration according to 5c, the compartment 56 for an external memory is also visible. The sectional plane runs through the receptacle 24 on the large-surface side, in which the flange plate 34 with the holding flange 35 attached to it is inserted. As explained, the receptacle 24 is pocket-shaped, wherein the flange plate 34 rests on the bottom 30 and is positionally fixed via fastening screws and/or dowel pins. The holding flange 35 has a profile that allows different scanning devices to be attached, which are usually operated in a stand-alone manner. In other words, according to the concept according to the invention, the platform 8, which is configured with standard connections, so to speak, can be equipped with different scanning devices, cameras, or the like. In the illustration according to FIG. 5c, battery cells 63 of the accumulators 10a, 10b, 10c, 10d are still visible.

FIG. 6 shows a variant of the configuration example according to FIGS. 5a, 5b in a view from a rear side. In this illustration, a rear wall 54 can be seen which is rounded and merges into the large surface 15, on which the receptacle 24 facing upward with the flange plate 34 and the holding flange 35 is formed in FIGS. 5a, 5b. A corresponding receptacle 24 is configured on the slanted surface 13, which is not visible in FIG. 6 and faces away from the viewer.

For improved handling of the platform 8, in this configuration example, a compartment 56 may be provided at the rear side into which an external memory can be inserted. This compartment 56 is then closed after insertion of the memory. In principle, a handle or handle recess may also be provided in this area to simplify handling of the platform 8 with any laser scanner that may be arranged thereon. In the configuration example shown in FIG. 6, the two retainers 50, 52 described above for the accumulators 10a, 10b, 10c, 10d are also clearly visible, wherein only the accumulators 10c, 10d are shown in FIG. 6. No accumulators are inserted in the rear retainer 50. It can be seen in this illustration that the two retainers 50, 52 are each configured with the separation wall 58, 60, which prevent direct contact of the two adjacent accumulators 10c, 10d. The outer circumference of the accumulators 10a, 10b, 10c, 10d is in each case stepped back somewhat along a circumferential contour 62, wherein the stepped-back part enters a receptacle 64, surrounded by the retainer walls 53a, 53b, of the respective retainer 50 and is held there in a precisely fitting manner, in particular in a form-fitting manner and also in a force-fitting manner, for example by a latch or the like. In the inserted state, a front face 66 of the separation wall 58 terminates with the large area 68 of the respective accumulator 10d visible in FIG. 6, so that there is practically no protrusion and the accumulators 10a, 10b, 10c, 10d are also reliably secured in their functional position. The sectional view also shows the contacts 65a, 65b for supplying power to the components.

Accordingly, when assembled, the platform 8 ideally forms a structural unit with virtually no protrusions, so that any damage during mobile measurement is virtually ruled out, wherein the design is adapted to that of the laser scanner. The platform 8 also forms a kind of mechanical buffer between the carrier unit, for example the stand or the holding frame of the backpack, and the laser scanner, so that the latter is protected from damage.

FIG. 7 again schematically shows the essential assemblies of the mobile scanning assembly according to the invention. As explained above, this comprises a laser scanner 2, for example at least one Z+F IMAGER®, which may be mounted on a platform 8 according to the invention as shown in FIGS. 5a, 5b. This laser scanner 2 communicates via a radio link, for example W-LAN, with the external computer, for example the handheld device 16, via which a pre-registration can be carried out in the field—this is indicated in FIG. 6, top left. Real-time preview scans of the SLAM data acquired via the mobile scanning assembly 1 can also be displayed on this handheld device. The handheld device 16 may also be directly connected to the platform 8, for example, to control and monitor SLAM acquisition.

As explained above, the laser scanner 2 is in data connection, for example via a LAN, with the platform 8, via which an evaluation of the location data and the 3D cloud of points acquired via the laser scanner 2 takes place. Depending on the configuration, this laser scanner 2 may be operated in the MMS/SLAM-rotation mode and in profile mode to generate a highly accurate trajectory. As explained, the platform 8 may be configured with an external interface for connecting an SSD 42 or a USB stick, via which the data acquired by the onboard PC 40 can be read out and transmitted to a central processor 44. Of course, this transmission can also be contactless.

As already explained at the beginning, the onboard PC 40 can synchronize with the connected laser scanners 2, 2′ due to its powerful CPU and can store all stationary or mobile data of a project locally on the platform 8. The scans can also be registered with each other and with the SLAM data. In principle, it is also possible to perform processing of the data (data filter, person recognition and masking (data protection), target recognition, colorization, a data export, etc.) via the onboard PC 40. This processing can of course also take place subsequently, for example in the office.

The stationary data is then copied to the external memory 42 together with the SLAM data. If, for example, this is removed and inserted into the central processor 44, the entire project, for example stationary scans and SLAM data, can be evaluated together without having to download any additional data from the laser scanners 2.

Furthermore, preview scans of the SLAM data in the field can be synchronized to the laser scanner 2 and can be integrated into the project. This means that the previous field workflow can continue to be used, as described, for example, in the prior art described at the beginning according to EP 3 056 923 A1 of the Applicant.

The laser scanner 2 can then send all data of a project (stationary scans and SLAM data) to the handheld device 16, where the registration can then be made or corrected. The handheld device 16 synchronizes the changes back to the laser scanner 2, which in turn synchronizes the changes to the platform 8 and the external memory 42 connected to it.

FIG. 8 shows a concept corresponding to FIG. 1, in which the mobile scanning assembly 1 (similar to FIG. 3A) is mounted on a cargo backpack 12. The platform 8 is attached with its bottom wall 28 to a carrier frame 70 of the cargo backpack 12 in the form of a back frame with shelf in such a way that the slanted surface 13 points obliquely upward (view in FIG. 8). A laser scanner 2 is then attached to the receptacle 24 of the slanted surface 13, which in the configuration example shown is configured as a 3D laser scanner (Z+F IMAGER®). The vertical axis X of the laser scanner 2 is thus adjusted to the vertical line in accordance with the position of the slanted surface 13. In the illustration according to FIG. 8, two accumulators 10c, 10d can also be seen, which can be removed from or inserted into the platform 8 laterally without any obstruction.

FIG. 9 shows a variant of a mobile scanning assembly 1 that can be mounted on a SKID or an AGVS, for example. The scanning assembly 1 is configured with a support construction 70 that is fixable on this portable carrier device (means of transport). This has a base plate 72, on which a supporting column 74 with a support bracket 76 is arranged, on which the aforementioned platform 8 is mounted. This mounting is done in such a way that the large surface 15 with the receptacle 24 points upward, to which a 3D laser scanner 2 (Z+F IMAGER®) of the Applicant is fixed in position in this configuration example. Furthermore, another laser scanner 2′ is held on the base plate 72 via a base 78, which in the configuration example shown is configured as a 2D laser scanner and thus permits profile measurement. The Z+F PROFILER® laser scanner of the Applicant is particularly suitable for this purpose. The contact surface of the base 78 and thus the angle of attack of a rotor 80 of the 2D laser scanner 2 can be adjusted via a pivot device 81. Furthermore, a bridge 82 is connected to the base 78, which bridges the 2D laser scanner 2′ and on which a color camera assembly, for example of the type Z+F MapCam®, is arranged. With such a camera assembly, the corresponding color information can be mapped to the measurement data acquired by the 2D-laser scanner 2′ in one step. The cameras 86 (only one of which is marked with a reference sign in FIG. 9) have high-resolution sensors and are arranged in such a way that the common field of view covers the entire measuring range of the 2D scanner 2′ without parallax. The high frame rate of the cameras enables the production of gapless and sharp color images at speeds of up to 90 km/h. Such a camera system provides very realistic and parallax-free color information.

The cameras 86 are oriented along the circumferential profile to be detected, but also in the direction of travel of the mobile carrier device, so that the entire environment can actually be detected via the color cameras.

In the illustration according to FIG. 10, the scanning assembly 1 is mounted on a pushcart 88 (SCADDY®), which is pulled or pushed by hand through the area to be measured. The basic structure of the scanning assembly 1 in FIG. 10 is the same as in FIG. 9, wherein no camera assembly 84 is mounted on the bridge 82. An external PC 92 is mounted on a PC retainer 90 in this configuration example, which is connected to the onboard PC 40 of the platform wirelessly or via connecting cables, so that data evaluation is supported via the external PC 92. However, the scanners 2, 2′ are essentially controlled via the onboard PC 40 of the platform 8. Such a concept also allows components, for example one of the laser scanners, to be controlled separately via the PC 92.

Finally, FIG. 11 shows a mobile scanning assembly 1, which can preferably be used to capture static scans. This scanning assembly 1 has a 3D laser scanner 2 that is attached to a stand retainer 94 of a stand 26 via the platform 8 according to the invention. In the configuration example shown, this is configured with a wheeled frame 96 so that it can be relatively easily adjusted to the desired scanning positions. In the configuration example according to FIG. 11, the platform 8 is arranged in such a way that the large surface 15 with the receptacle 24 is oriented upward (view according to FIG. 11), so that the axis X of the 3D laser scanner runs in the vertical direction (perpendicular to the support surface of the stand 26). Instead of the wheeled frame 96 shown, a trolley, dolly or the like may also be used in principle—such wheeled frame arrangements are available at most surveyors or can be retrofitted at low cost, so that flexible use of the mobile scanning assembly 1 is ensured at low cost.

As shown above, the construction of the variable platform 8 makes it possible to mount different laser scanner types 2, 2′ on a wide variety of support devices depending on the environment to be measured/measurement object, thus ensuring an optimal scanning position.

As explained above, the mobile data set can be acquired by combining two 3D laser scanners or two 2D laser scanners positioned at an angle to each other or a combination of a 3D laser scanner with a 2D laser scanner.

Disclosed is a platform for a mobile scanning assembly configured with at least two receptacles for scanning devices.

### LIST OF REFERENCE SIGNS

1 mobile scanning assembly
2 laser scanner
4 tripod
6 camera system
8 platform
10 accumulator
11 rotor
12 cargo backpack
13 slanted surface
14 laser beams
15 large surface
16 handheld device
17 narrow side
18 battery compartment
20 thread hole
22 thread hole
24 receptacle
26 stand
28 bottom wall
30 bottom
32 fastening thread
34 flange plate
35 holding flange
36 housing region
38 housing region
40 onboard PC, communication module
42 SSD
44 central processor
46 side wall
48 side wall
50 retainer
52 retainer
53 retainerswand
54 rear wall
55 receptacle space
56 compartment
58 separation wall
59 microcontroller board (INS)
60 separation wall
61 board power supply
62 circumferential contour
63 battery cell
64 receptacle
66 front face
68 large area
70 support construction
72 base plate
74 supporting column
76 support bracket
78 base
80 rotor
81 pivot device
82 bridge
84 camera assembly
86 camera
88 pushcart
90 PC retainer
92 external PC
94 stand retainer
96 wheeled frame

1. A platform for a mobile scanning assembly (1), with at least two receptacles (24) for selective and detachable positioning of a scanning device or for positioning of at least two identically constructed or different scanning devices, which are also independently operable, wherein the receptacles (24) are positioned in an optionally adjustable angle relative to each other.

2. The platform according to patent claim 1, with several accumulators (10) connected in such a way that individual accumulators (10) can be replaced or recharged without interrupting the scanning process.

3. The platform according to one of the preceding patent claims, wherein it is configured with two receptacle walls set at an angle relative to each other and on each of which a receptacle (24) is formed.

4. The platform according to patent claim 3, with a bottom wall (28) which, together with the receptacle walls, side walls (46, 48) and a rear wall (54), forms a receptacle space for an electronic unit with an onboard pc (40) for controlling components of the mobile scanning assembly (1) and/or for evaluating measurement signals.

5. The platform according to patent claim 4, wherein the electronic unit also has a DC/DC converter for the accumulators (10).

6. The platform according to patent claim 2 or one of the claims related to patent claim 2, wherein retainers (50, 52) for the accumulators (10) are formed on the side walls (46, 48).

7. The platform according to one of the preceding patent claims, wherein the retainers (50, 52) hold the accumulators (10) in a form-fitting and force-fitting manner.

8. The platform according to patent claim 6 or 7, wherein a retainer for two accumulators (10a, 10b; 10c, 10d) is formed on each of the side walls (46, 48) and/or on the rear wall (54).

9. The platform according to one of the preceding patent claims, wherein the receptacles (24) for the scanning devices are identically configured.

10. The platform according to one of the preceding patent claims, wherein the receptacles (24) are each pocket-shaped recesses in the receptacle walls, into each of which a retainer (50, 52) for a scanning device is inserted.

11. The platform according to patent claim 10, wherein the retainer (50, 52) is configured with a flange plate (34) that is precisely inserted into the recess and carries a holding flange (35) for the scanning device which is configured, preferably via dowel pins, for mounting the scanning device in a rotation-proof manner.

12. A mobile scanning device with a platform (8) according to one of the preceding patent claims, wherein at least one scanning device is attached to a receptacle (24) and is in power and signal connection with the electronic unit.

13. The scanning assembly according to patent claim 12, wherein the platform (8) is mounted on a mobile carrier unit, such as a cargo backpack (12), a SKID, an AGVS or a pushcart (88).

14. The scanning assembly according to patent claim 13, wherein a 3D laser scanner (2) and/or a 2D laser scanner (2′), a device for location detection and optionally a color camera arrangement (84) are arranged on the mobile carrier unit.
